(19) United States
(12) Patent Application Publication
(10) Pub. No.: US 2014/0006972 A1
(43) Pub. Date: Jan. 2, 2014

(54) Systems and Methods Providing Integrated Communication and Task Management

(71) Applicant: Nerijus Celkonas, San Jose, CA (US)

(72) Inventor: Nerijus Celkonas, San Jose, CA (US)

(21) Appl. No.: 13/606,310

(22) Filed: Sep. 7, 2012

Related U.S. Application Data
(60) Provisional application No. 61/667,337, filed on Jul. 2, 2012.

(51) Int. Cl. G06F 15/16; G06F 3/01

(52) U.S. Cl. 715/753; 709/206

(57) ABSTRACT

Some embodiments provide a collaboration platform that integrates communication and task management functions by replacing the single message primitive of traditional email with a message primitive, a question primitive, and a task primitive and by replacing the inbox and sent folder organizational management with a set of workflows that organize the primitives under three organizational headings. The message primitive is a construct for passing a message from a sender to a receiver without requiring a response as defined by a first workflow. The question primitive is a construct by which a sender asks a receiver a question for which an answer is required as defined by a second workflow. The task primitive is a construct by which a sender assigns a task to a receiver for the receiver to complete. A third workflow ensures that the receiver performs the task and the sender approves completion of the task.

### CLAIM OF BENEFIT TO RELATED APPLICATIONS

This application claims the benefit of U.S. provisional application 61/667,337, entitled “Systems and Methods Providing Integrated Communication and Task Management”, filed on Jul. 2, 2012. The contents of application 61/667,337 are hereby incorporated by reference.

### TECHNICAL FIELD

The present invention relates to the fields of communication and task management.

### BACKGROUND ART

Collaboration is central to an effective and efficient business. A primary component driving such collaboration is the communication infrastructure over which some if not most of this collaboration occurs. New communication tools have been introduced over time to improve and offer new services to compliment the communication infrastructure. Where one tool falls short in providing one or more specific services, one or more other tools have been developed to fill the gap. However, email remains the principal communication tool because of its simplicity, general adaptable usage, and low cost of deployment relative to the usage of the service.

For the most part, email is a general use paradigm for passing a message from a sender to one or more recipients. Other functionality, such as forwarding, attachments, and calendaring, are also provided and integrated with most email applications, but such functionality merely serves to compliment the general use paradigm as opposed to adapt the usage paradigm to better serve business needs.

One specific area that is improperly served by email is task management. In any business, tasks are delegated from managers to employees, questions regarding a task are floated between employees, and inquiries regarding the status of a task are made. While the general communication functions of email has been adapted for such purposes, it should be clear that this same generality can create the scenario whereby delegated tasks go unaddressed, questions go unanswered, and status history of a task is unknown or is mismatched. Specifically, email does not offer the necessary functionality to automatically manage tasks and ensure that questions do not go unanswered. Instead, it is up to the user to communicate with other users, follow-up to ensure the desired information is obtained, and then attribute the information to the task to ensure that tasks are completed, questions are answered, and status is known.

Due to these and other shortcomings of traditional email, there is need for an enhanced communication platform whereby communication is seamlessly tied with task management. Such an enhanced communication platform should provide a more effective and holistic communication tool that addresses fundamental needs of a business including tightly integrating and adapting traditional email communication with task management. As a result, there is a need for an enhanced communication platform that enables traditional email communication while managing tasks assigned to others, ensuring questions relating to a task are properly addressed, and tracking the status of tasks effectively and efficiently within the same platform over which traditional email communication occurs. Furthermore, there is a need for a simplified but effective graphical user interface that integrates email communication with task management such that business collaboration occurs from a single unified interface.

### SUMMARY OF THE INVENTION

It is an objective of the present invention to define systems, methods, and computer software products to more efficiently and more effectively collaborate within a business setting. More specifically, it is an objective to provide a unified platform that introduces new paradigms for seamlessly integrating communication and task management functions within a single interface or application.

To achieve these and other objectives, some embodiments provide an enhanced communication platform to replace the use of email as the primary tool for collaborating within a business setting. The enhanced communication platform achieves these and other objectives by replacing the single message primitive of traditional email applications with three message primitives and by replacing the inbox and sent folder organizational management of traditional email applications with a set of workflows for each primitive. The workflows automatically organize the primitives under three organizational headings based on their current state in the workflows.

The three primitives include at least a message primitive, a question primitive, and a task primitive. The message primitive is a construct for passing a message from a sender to a receiver without requiring a response as defined by a first workflow. The question primitive is a construct by which a sender asks a receiver a question for which an answer is required as defined by a second workflow. The second workflow ensures that the question does not go unanswered by the receiver and that the sender is reminded of an outstanding question until that question is answered by the receiver. The task primitive is a construct by which a sender assigns a task to a receiver for the receiver to complete. A third workflow manages the status of the task, ensuring that the receiver performs the task and the sender approves the completion of the task.

The workflows manage the allocation of the primitives under the three organizational headings. The three organizational headings include at least a to-do organizational heading, a follow organizational heading, and a history organizational heading.

For the receiver of a primitive, the workflows enter any unread messages of message primitives, any unanswered questions of question primitives, and any incomplete tasks of task primitives under the to-do organizational heading of the receiver's account. The workflows automatically transition a message primitive from the receiver's to-do organizational heading to the history organizational heading once the message contained in the message primitive is read and closed by the receiver. The workflows transition a question primitive from the receiver's to-do organizational heading to the history organizational heading when the question asked in the question primitive is answered by the receiver. The workflows maintain a task primitive under the receiver's to-do organizational heading but change the status of the task primitive when the receiver indicates that he/she has performed the assigned task. The task primitive is moved under the history organizational heading of the receiver account when the sender assigning the task to the receiver confirms that the task is indeed complete. In this manner, the message, question, and task primitives can address different specific business functions. Moreover, the associated workflows remove the manual oversight needed to manage such functions. Instead, the workflows automate the management of the messages, questions, and tasks and ensure that the messages, questions, and tasks are addressed as intended by the sender.

For the sender of a primitive, a sent task primitive is entered under the history organizational heading and any new task primitives received by the sender are entered under the to-do organizational heading of the sender account. Unanswered questions that have been asked by the sender are entered under the follow organizational heading until an answer is received. Once the answer to a question primitive is received, the answer is entered under the to-do organizational heading of the sender account and once the answer is read, the answer is grouped with the question primitive to which it relates as a conversation that is entered under the history organizational heading. Similarly, a task primitive that is sent by a sender and not yet completed by the recipient is assigned under the follow organizational heading of the sender account. The task primitive can be classified under the follow organizational heading as an overdue task, a task that is awaiting approval, or as an incomplete task that is not yet overdue. From this organization, the sender can readily identify unanswered questions that are pending, the status of incomplete tasks, and which recipients the sender has asked questions or assigned tasks to. Once the sender approves a task that is awaiting approval, the task is relocated from the follow organizational heading to the history organizational heading of the sender account.

Collectively, the primitives and workflows of the enhanced communication platform automate the management of questions and tasks for users while still providing an interface that mirrors the ease and familiarity of traditional email. In so doing, the enhanced communication platform offers specialized business functions beyond traditional email communication to better serve collaborative needs in a business setting.

### BRIEF DESCRIPTION OF THE DRAWINGS

In order to achieve a better understanding of the nature of the present invention, preferred embodiments for the enhanced communication platform will now be described, by way of example only, with reference to the accompanying drawings in which

FIG. 1 presents various components of the enhanced communication platform in accordance with some embodiments.

FIG. 2 presents a message primitive creation form that is in accordance with some embodiments.

FIG. 3 presents a question primitive creation form that is in accordance with some embodiments

FIG. 4 presents a task primitive creation form that is in accordance with some embodiments.

FIG. 5 details the workflow of the message primitive in accordance with some embodiments.

FIG. 6 details the workflow of the question primitive in accordance with some embodiments.

FIG. 7 details the workflow of the task primitive in accordance with some embodiments.

FIG. 8 presents a graphical interface that displays the primitives that are entered under the to-do organizational heading for a particular user in accordance with some embodiments.

FIG. 9 presents a graphical interface that displays the follow organizational heading for a user in accordance with some embodiments.

FIG. 10 illustrates an exemplary interface presenting the detailed view of a task that is awaiting user approval in accordance with some embodiments.

FIG. 11 illustrates the interface when the user selects the UI element under all tasks and questions of the follow organizational heading for a specific contact in accordance with some embodiments.

FIG. 12 illustrates an expanded conversation for a task primitive in accordance with some embodiments.

FIG. 13 presents a graphical interface that displays the primitives that are entered under the history organizational heading for a particular user in accordance with some embodiments.

FIG. 14 illustrates a computer system or server with which some embodiments are implemented.

### DETAILED DESCRIPTION

In the following detailed description, numerous details, examples, and embodiments for systems and methods for the enhanced communication platform are set forth and described. As one skilled in the art would understand in light of the present description, these systems and methods are not limited to the embodiments set forth, and these systems and methods may be practiced without some of the specific details and examples discussed. Also, reference is made to the accompanying figures, which illustrate specific embodiments in which the systems and methods can be practiced. It is to be understood that other embodiments can be used and structural changes can be made without departing from the scope of the embodiments herein described.

The enhanced communication platform seamlessly integrates task management functionality with standard email functions. The task management functions automatically track and manage delegated tasks from an assignor to one or more assignees, automatically ensure that questions regarding a specific task are answered, and automatically track and manage the status of various tasks from conception to completion. Such functionality is possible through existing email albeit with extensive manual involvement by a user. This involvement opens the possibility for human error and can lead to unanswered questions, mismanaged tasks, and oversight on critical business functions. By automating the management of these functions, the enhanced communication platform streamlines and simplifies collaboration in the business setting.

To provide such functionality, the enhanced communication platform provides a new usage paradigm to supplant that of traditional email. Specifically, the enhanced communication platform supplants the existing email message primitive with three specialized primitives (hereinafter collectively referred to as “post primitives”) and supplants the inbox and sent folder organization workflow of an email application with an enhanced workflow that binds each primitive to a specific collaborative business function. In so doing, the enhanced communication platform offers a more holistic, comprehensive, and targeted solution for collaboration in the business setting.

In some embodiments, the enhanced communication platform is provided as an online application that is accessible from any web browser running on any network enabled device (e.g., smartphone, laptop, server, tablet, etc.). Network connectivity includes wired and wireless connectivity to a digital network such as the Internet.

The enhanced communication platform is a centralized system with back-end servers controlling the transfer of the primitives as well as controlling the workflows of the different primitives in accordance with the functionality that is described in the sections below. The transfer of the primitives occur using system specific protocols that, in some embodiments, include adaptations of the SMTP, POP, IMAP, and other mail transfer protocols. The system specific protocols facilitate either pull or push based transfer of the primitives. In some embodiments, control of the workflows for the primitives is in part determined by the system specific protocols. For instance, the system specific protocols conceptually encode state machines for automatically managing the primitives based on a sequence of actionable events that are performed in association with the primitives. The workflows may also be embodied as a set of rules that execute in conjunction with the system specific protocols. Generally, automatically managing the primitives involves ensuring that a question is answered, status of a task is tracked until completion, and reallocating the primitives under various organizational headings of the enhanced communication platform user interface. In the centralized system, the protocols are executed by the back-end servers of the platform.

In some embodiments, the enhanced communication platform is embodied as a decentralized or distributed system based on standalone applications that run locally on end user devices in conjunction with back-end servers. In this scenario, the back-end servers facilitate the transfer of the primitives between the applications. Each application then locally controls the workflows of the different primitives in accordance with the functionality that is described in the sections below. In this scenario, the platform involves client-side execution of the workflows, whereas the centralized system involves server-side execution of the workflows.

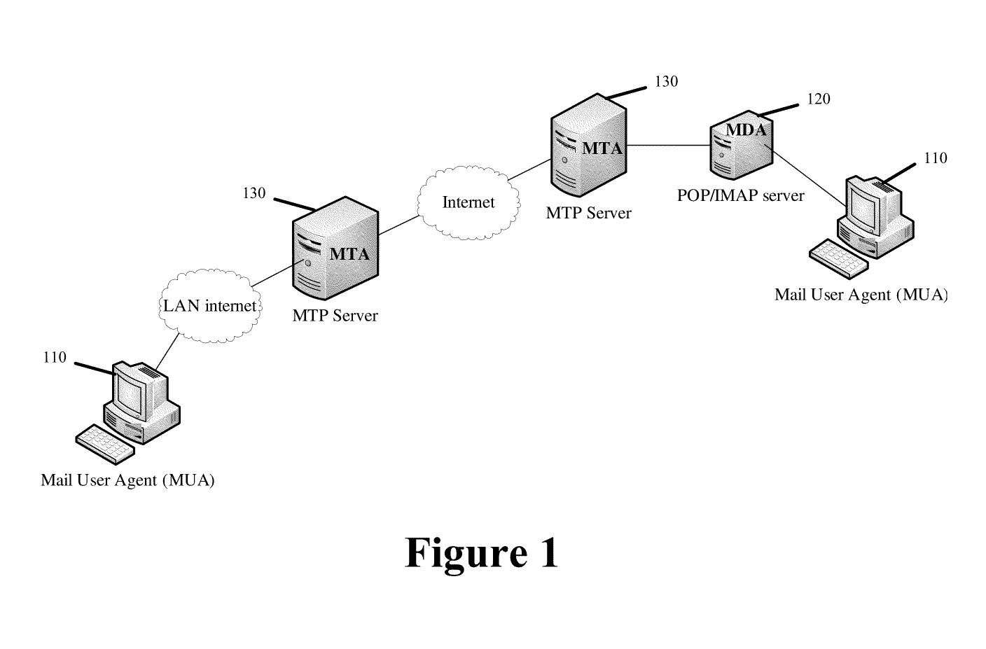

In either the centralized system or the decentralized system, the enhanced communication platform adapts common components of an email system for the transfer of the primitives and for controlling the transfer according to the defined workflows. Accordingly, the enhanced communication platform, as shown in FIG. 1, includes one or more Mail User Agents (MUAs) 110, Mail Transport Agents (MTAs) 120, and Mail Delivery Agents (MDAs) 130.

The MUA 110 is the software running on the end user device to interface with the enhanced communication platform. The MUA 110 presents the graphical user interfaces and can be responsible for the sending and receiving of the primitives on the end user device. In some embodiments, the MUA 110 sends and receives the primitives using the SMTP and POP protocols or some variation thereof. The MUA 110 may execute the workflows to control the presentation and allocation of the primitives. The MTA 120 is the component that is responsible for routing a primitive to and from other MTAs 120 and MUAs 110. The MDA 130 serves a similar role to the MTA 120 albeit for providing the interworking between the various MTAs 120. In a centralized system, the workflow control of the primitives can be performed in either the MTA 120 or the MDA 130.

In any case, the enhanced communication platform transforms a general computing device to a specialized device for collaborating in a business setting using the provided primitives in accordance with the workflows that are defined for the primitives. In other words, without the primitives and defined workflows of the enhanced communication platform, the functionality described below is unavailable or reduced on a general computing machine to that of standard email applications.

I. Post Primitives

Unlike traditional email that adapts the general email message primitive for all forms of collaboration (e.g., messaging, calendaring, reminders, etc.), some embodiments of the enhanced communication platform provide at least three different post primitives for collaborating in the business setting. In some embodiments, the three primitives include the message primitive, the question primitive, and the task primitive. Each of the primitives is associated with a different set of workflow rules in order to customize the functionality of each primitive for a specific collaborative function within the business setting. The workflows also automatically manage the allocation of the primitives within different organizational headings of a single graphical user interface in order to preserve the ease and familiarity of using traditional email and the single email primitive of traditional email. It should be apparent that the primitives are not defined by their naming convention. Rather, the primitives should be defined by their respective functions and workflows as discussed below.

A. Message Primitive

The message primitive of the enhanced communication platform is the construct that most resembles the traditional email message primitive. In other words, the message primitive is a construct that follows and operates under a set of workflow rules that closely resemble that of an email message primitive. In some embodiments, the workflow rules allow a user of the enhanced communication platform to generate and send a message primitive to one or more specified recipients, reply or reply-to-all users associated with a received message primitive, forward a message primitive to users, and delete the message primitive as some examples. The message primitive supports document, object, and URL attachments. The message primitive is intended as the basic and free form primitive for passing a communication from a sender to one or more recipients without workflow rules requiring a response or other action from the recipients of the message primitive.

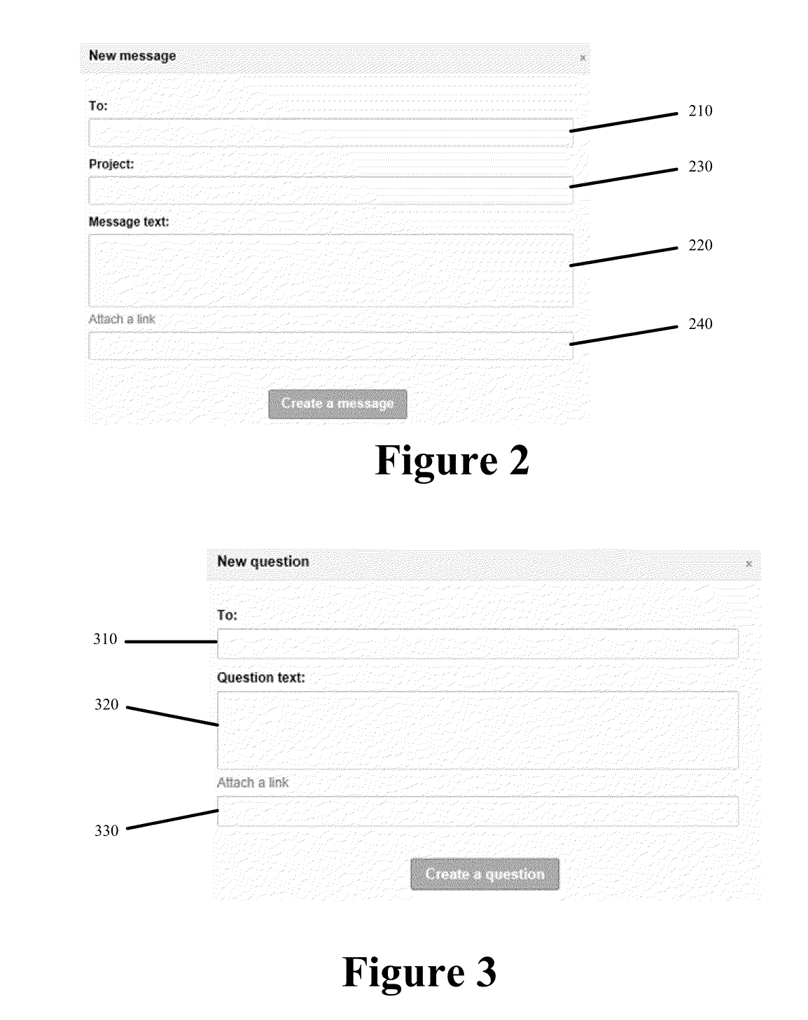

As shown by the create new message primitive form of FIG. 2, the message primitive is a construct containing fields for specifying one or more destinations/recipients for the message 210 and the text of the message 220. The construct optionally includes fields for specifying a project name 230 and a link 240 to attach a document or other object to send with the message primitive.

The one or more recipients for the message can be manually entered or selected from a list of contacts. In some embodiments, the list of contacts is stored by the enhanced communication platform and associated with an account or profile that the sender registers with the enhanced communication platform. In some embodiments, the recipients are specified using an email address for the recipients. Alternatively, other identifiers including usernames or names associated with accounts that have been registered in the enhanced communication platform can be used to specify the recipients for a message primitive and the enhanced communication platform automatically replaces the identifiers with the email addresses of the specified recipients. Multiple recipients are separately specified using a comma delimiter or some other delimiter. Suggestions to complete entry of a recipient are provided based on a sender's contact list.

The text of the message is the body or subject of the message primitive. This can include plain text or formatted text. In some embodiments, the title for a specific message primitive is automatically populated based on the first seven words of the text, though the user is allowed to modify the title in some embodiments.

The optional project name field is used to group receivers and to relate messages with a specific project. Users can enter a new project name or select from a suggested project list. Project suggestions are given only from projects that a user has earlier created.

The source for the message primitive is identified as the sender account used to generate the primitive. The sender registers at least one such account in order to access the enhanced communication platform. In some embodiments, the registrant can link its other existing email accounts to the enhanced communication platform account. In this manner, the enhanced communication platform account can serve as a unified account from which the user can manage several email accounts. The enhanced communication platform treats the incoming and outgoing email messages from the external accounts as a message primitive and those email messages are processed in accordance with the message primitive workflow described below.

As with traditional email, the enhanced communication platform provides reply, reply to all, forwarding, and other related functions for the message primitive. The message primitive can be sent to any email account whether the email account is created within the enhanced communication platform or other email service provider (e.g., Yahoo! Mail, Gmail, Hotmail, etc.). The message primitive is sent using standardized IMAP, POP, POP3, SMTP, HTTP, and/or MAPI protocols as some examples.

B. Question Primitive

The construct for the question primitive resembles that of the message primitive, however the question primitive is associated with a different set of workflow rules. The set of workflow rules associated with the question primitive ensure that a question presented as part of the construct is answered. Accordingly, the set of workflow rules defined for the question primitive allow users of the enhanced communication platform to ask questions to other users and automatically identify which questions have been asked but have not yet been answered from those questions that have been answered. In some embodiments, the user asking the question can specify a due date for an answer to a question. Should a question not be answered within the specified due date, the enhanced communication platform automatically reminds the user receiving the question to answer the question while also notifying the asking user that the question remains unanswered. The set of workflow rules for the question primitive are described in Section II below.

As shown by the create new question primitive form of FIG. 3, the question primitive is a construct containing fields for specifying the recipient that is to receive and answer the question 310 and the text for the question 320. The construct optionally includes a link field 330 to attach a document or other object to send with the question.

To execute the workflow that is defined for the question primitive, the question primitive should be sent from a first user account that is registered with the enhanced communication platform to a second user account that is also registered with the enhanced communication platform. From these accounts, the enhanced communication platform and, more specifically, the workflow defined for the question primitive can track when a question is answered and thereby automatically manage the question by reallocating the question primitive and/or a received answer under the appropriate organizational headings of the enhanced communication platform user interface.

The question primitive can also be sent from any email account that a user has imported to the enhanced communication platform to any other email account of any service provider. However, the specialized set of workflow rules associated with the question primitive will generally not be applicable when the sender and/or recipient of the question primitive is not associated with an account that is registered with the enhanced communication platform. In such cases, the question primitive is encapsulated in a message primitive or as a traditional email communication and sent using standardized email protocols (e.g., SMTP) that may support none or a reduced set of the corresponding workflow functionality that automatically manage the question primitive by ensuring that the question does not go unanswered.

The question text identifies the question that is being asked. A title for the question is automatically populated by the first seven words of the question, but the title can be changed by the user.

C. Task Primitive

As with the message primitive and the question primitive, the task primitive is associated with its own set of workflow rules that differ from those of the other primitives. The set of workflow rules associated with the task primitive allow for the status of a given task to be tracked, updated, and presented from conception to completion. Additionally, the set of workflow rules ensure that a task delegated to one or more users is timely completed by the one or more users and that the completion of that task is approved by a supervisory user. The user that creates and assigns or otherwise delegates a task to another user is referred to hereinafter as the assignor, while the user that receives an assigned task is referred to hereinafter as the assignee.

The assignor can specify a due date for which a status update, such as completion of the task, is required by the assignee. Should the assignee not provide a status update by the specified due date, the enhanced communication platform automatically follows up with the assignee while also notifying the assignor. When a status update is provided by the assignee, the assignor then performs a supervisory check to ensure that the status update indicated by the assignee is accurate. For example, the assignor confirms that the assignee has indeed completed a task and that the task is completed to the specification of the assignor. The set of workflow rules also automatically track a task for each of the assignor and the assignee by relocating the task primitive under appropriate organizational headings within the user interface of each user based on the status of the task.

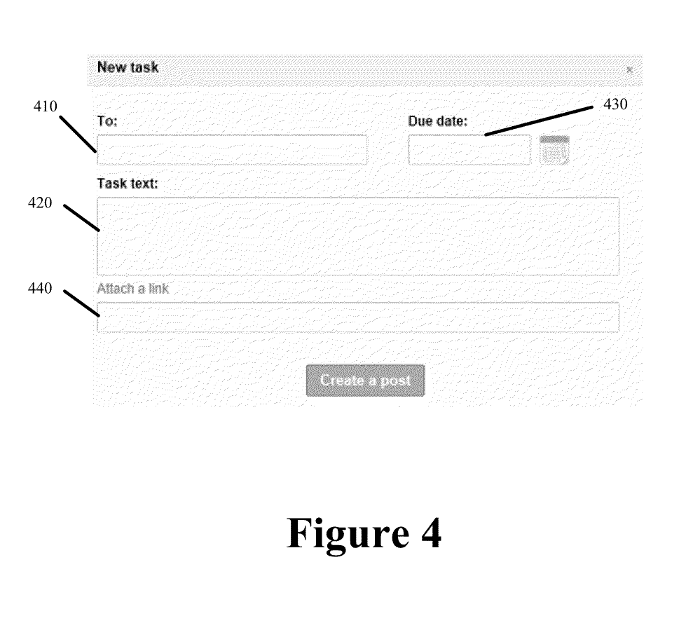

As shown by the create new task primitive form of FIG. 4, the task primitive is a construct containing fields for specifying the task assignee 410 and the text defining the task 420. The construct optionally includes a due date field 430 and a link field 440 to attach a document or other object to send with the task.

As with the question primitive, the enhanced communication platform supports the workflow for the task primitive when the assignor sends the task primitive from an account that the assignor has registered with the enhanced communication platform to an assignee account that is registered with the enhanced communication platform. However, the task primitive can be sent from any email account that a user has imported to the enhanced communication platform to any other email account of any service provider. In such cases, the task primitive is encapsulated in a message primitive or as a traditional email communication and sent using standardized email protocols that may support none or a reduced set of the corresponding workflow functionality that automatically manage the task primitive by ensuring that the task does not go unattended after being assigned.

II. Organizational Workflow

To more efficiently and effectively manage the message, question, and task primitives, the enhanced communication platform does away with the common inbox and sent organization of a typical email application. This organization is a byproduct of a one step workflow used by all traditional email applications, whereby all incoming email messages are placed in the inbox and all outgoing email messages are placed in the sent folder. Users can manually enhance this workflow by moving messages to other folders. Users can also manually specify filters to enhance this workflow such that messages are automatically moved based on the rules that the user manually specifies for the filters. In any case, email applications remain a single step workflow, requiring users to manually enhance the workflow for more specialized needs. Moreover, the manual enhancements supported by traditional email applications do not provide the more intelligent bidirectional question and task management workflows of the enhanced communication platform.

Specifically, the question primitive workflow is a bidirectional workflow in which the sender can readily distinguish between unanswered questions and answered questions that he/she has asked of various recipients. Similarly, the bidirectional workflow assists the recipient in differentiating between outstanding questions that he/she has not answered from answered questions. The differentiation occurs as a result of the question primitive workflow's automatic designation of unanswered and answered questions to separate organizational headings in the user interface. Such automatic designation reduces clutter in the user interface, thereby allowing the user to skip the step of manually having to identify unanswered questions before being allowed to answer them. Instead, the automatic designation provided by the question primitive workflow allows the user to focus directly on what questions remain unanswered, thereby saving the user time while reducing the possibility of a question going unanswered as a result of human oversight.

Similarly, the task primitive workflow is a bidirectional workflow in which the assignor can readily distinguish between incomplete tasks and completed tasks while ascertaining the status of each task and the days left to complete the task. The assignee can readily identify tasks that he/she has yet to complete from completed tasks while being automatically reminded of incomplete tasks and the remaining number of days by which the task should be completed.

To remedy the shortcomings associated with the one step workflow of traditional email applications while preserving the ease and familiarity of traditional email applications, the interface of the enhanced communication platform automatically organizes the message, question, and task primitives under three new organizational headings. The organization of the primitives under the organizational headings occurs according to the set of workflow rules that are defined for each of the three primitives. In some embodiments, the organizational headings include the “to-do”, “follow”, and “history” headings that supplant the inbox and sent folders of a traditional email application. Collectively, the post primitives, organization headings, and the set of workflow rules provide a new platform that better realizes the collaborative objectives of a business.

The organizational headings are presented and accessible through an interactive user interface (UI). More specifically, each organizational heading is accessible via a UI element that is presented within the interactive UI. Invocation of the “to-do” UI element causes the to-do organizational heading to become frontmost with each primitive that is organized under that heading to be displayed. Similarly, invocation of either the follow UI element or the history UI element causes the corresponding organizational heading to become frontmost with the underlying primitives organized under that heading to be displayed in the UI. Conceptually, each organizational heading functions as a different state of the state machine specified by the workflow defined for each of the three primitives.

A. Message Primitive Workflow

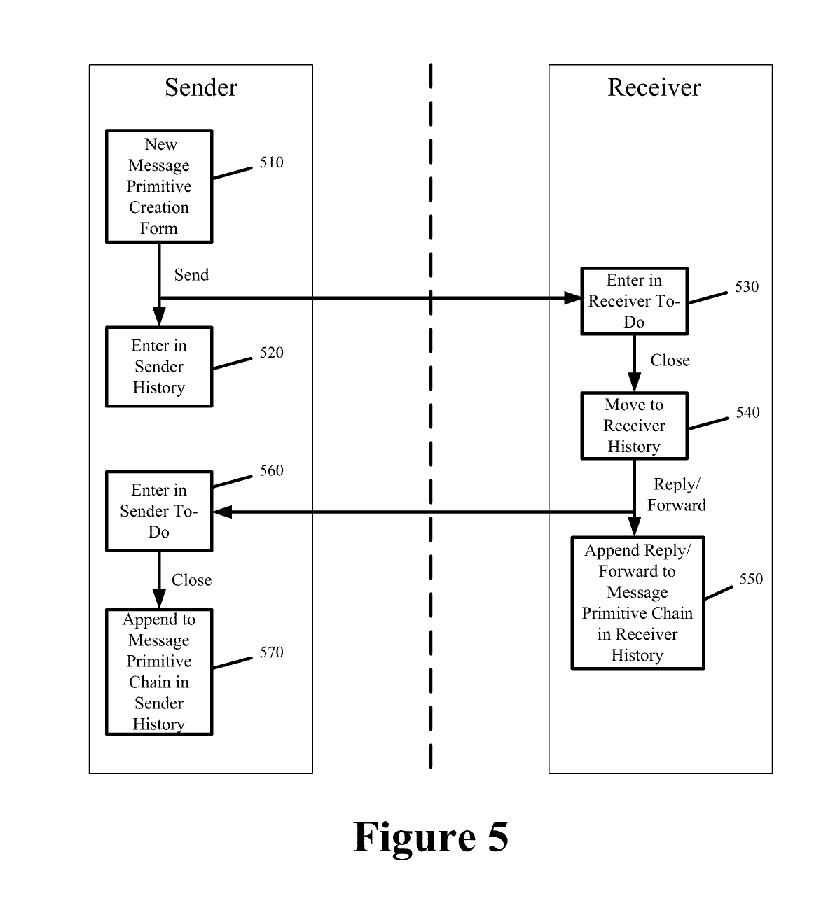

FIG. 5 details the workflow of the message primitive in accordance with some embodiments. The workflow corresponds to how the enhanced communication platform automatically organizes the message primitive within the various organizational headings. The workflow is illustrated by the state machine states of the message primitive as a sender and receiver interact with the message primitive from their respective accounts.

The workflow commences when the sender creates (at 510) a new message primitive using the form presented above with reference to FIG. 2 and sends the created message primitive to the receiver. Once the message primitive is sent, the message primitive is entered (at 520) under the history organizational heading of the sender account. On the receiver side, the message primitive is received at the account of the receiver. The message primitive is entered (at 530) under the to-do organizational heading along with any other primitives that the receiver has yet to view. The to-do organizational heading therefore serves as the repository for any posts (e.g., message primitive, question primitive, or task primitive) that are received but have yet to be closed, answered, or completed.

After the receiver views and closes the message primitive in addition to performing any other actions, the enhanced communication platform moves (at 540) the message primitive to the receiver's history organizational heading. Should the receiver reply to the message primitive, the reply is also stored along with the received message primitive under the history organization heading. Moreover, the reply is combined (at 550) with the original received message into a conversation. The conversation tracks all subsequent posts including replies, forwarded messages, etc. that stem from a single post primitive which in this example is a message primitive. In this manner, all actions that followed from the sending or receiving of the message primitive can be easily accessed and viewed from a single primitive. The reply passes from the receiver to the sender as a new instance of a message primitive although it may be tagged such that it is associated as part of the originally sent message primitive.

A reply from the receiver to the sender will then be entered (at 560) under the to-do organizational heading of the sender account. The reply remains in the sender to-do organizational heading until the sender closes the reply. Ordinarily, the sender opens the reply, views the contents of message, and performs any other actions (e.g., replying) before closing the message primitive. Opening the message primitive involves selecting the message primitive from under the to-do organizational heading and closing the message primitive involves selecting a close button or UI element when the message primitive is open or simply listed in summary form under the to-do organizational heading. When the sender closes the receiver's reply, the receiver's reply is moved (at 570) from the sender's to-do organizational heading to the sender's history organizational heading where it is combined with the originally sent message primitive as part of the combination. Follow-up actions that are sent from the sender to receiver are also stored as part of the conversation under the history organizational heading.

This workflow continues so long as a conversation is kept alive with replies or other follow-up actions. A single message primitive within a conversation can be deleted at any time, thereby removing the deleted message primitive from under the history organizational heading of the user account from which the deletion operation occurs. Additionally, an entire conversation of message primitives can be deleted at any time, thereby removing the entire conversation from the history organizational heading of the user account from which the deletion operation occurs.

B. Question Primitive Workflow

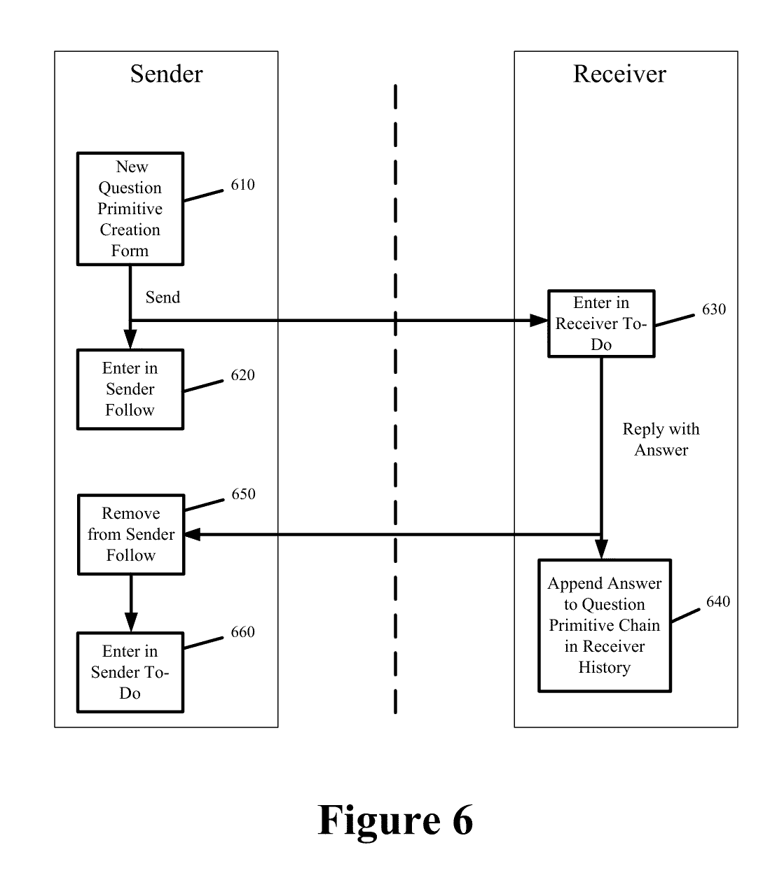

FIG. 6 details the workflow of the question primitive in accordance with some embodiments. This figure illustrates a workflow for the question primitive as it passes between a sender and a receiver of the question primitive.

The workflow commences when the sender creates (at 610) a new question primitive using the form presented above with reference to FIG. 3 and sends the question primitive to the receiver. Since the workflow for the question primitive requires a response from the receiver and the sender wants to track outstanding questions that have yet to be answered, the question primitive is automatically stored (at 620) under the follow organizational heading of the sender account once it is sent. The question primitive remains under the follow organizational heading of the sender until the receiver provides a reply to answer the question. This differs from the workflow of the message primitive, wherein the message primitive is entered under the history organization heading of the sender account once the message primitive is sent. This difference highlights how the question primitive is provided for a different collaborative purpose than the message primitive. Specifically, instead of grouping message primitives that require no response with question primitives that do require a response in the same folder, the workflows defined herein automatically organize the question primitives under a separate organizational heading than the message primitives. In so doing, by pulling up the follow organizational heading, the sender can quickly and readily identify which questions remain unanswered and outstanding. On the receiver side, the question primitive is received at the account of the receiver and entered (at 630) under the to-do organizational heading along with any other primitives that the receiver has yet to close, answer, or complete. The workflow of the question primitive also differs from that of the message primitive by virtue of restricting the actions that the receiver can take on the question primitive and by virtue of the rules that control when the question primitive is moved from the to-do organizational heading to the history organizational heading of the receiver account. To ensure that a question primitive is answered by a receiver, the workflow restricts the receiver to follow-up to the question primitive by replying to the question that was asked by the sender. The receiver cannot move the question primitive from the to-do organizational heading to the history organizational heading by closing the question primitive without providing an answer to the asked question. If no answer is provided, the question primitive remains under the to-do organizational heading.

Once the receiver submits a reply to answer the question asked in the question primitive, the enhanced communication platform automatically moves (at 640) the question primitive to the history organizational heading of the receiver, the question primitive is removed (at 650) from the follow organizational heading of the sender account, and the reply is entered (at 660) under the to-do organizational heading of the sender until it is read and closed by the sender. Additionally, the reply may be combined as part of a conversation with the question primitive that initiated the question to the receiver. In this manner, the sender can identify the question he asked and the corresponding answer received from the entity to which the question was sent. In some embodiments, the reply is sent as a message primitive with tags to associate the message primitive as a reply to the question primitive. In some embodiments, the reply is sent as a question primitive with tags to identify the reply as an answer to the sender's question primitive.

The sender can stop the conversation upon receipt of the reply containing the answer to the question primitive by viewing and then closing the reply entered under the to-do organizational heading. However, the sender can submit a follow-up question in the form of a second question primitive to the receiver in which case the question primitive is moved back under the follow organizational heading of the sender account and re-entered under the to-do organizational heading under the receiver account. This may occur when the sender is not satisfied with the receiver's answer. Lastly, the sender can continue the conversation by submitting a message primitive instead of a question primitive to the receiver when the sender requires no further response from the receiver. The sender may do so when thanking, for example, the receiver for providing the answer.

C. Task Primitive Workflow

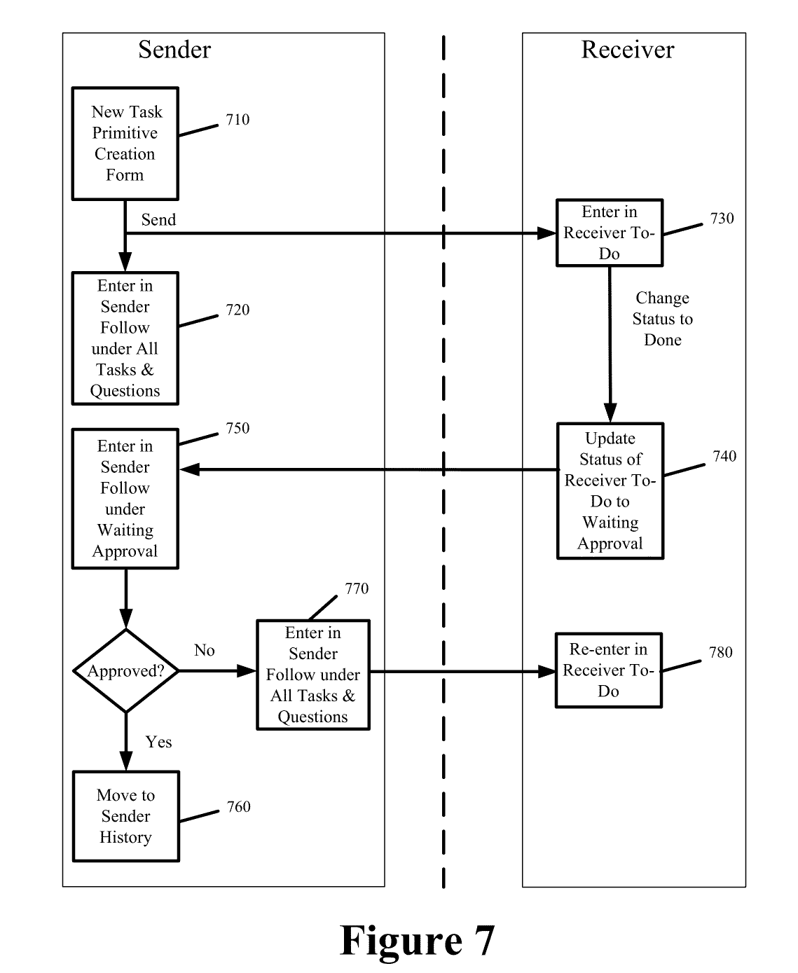

FIG. 7 details the workflow of the task primitive in accordance with some embodiments. The workflow commences when the assignor or sender creates (at 710) a new task primitive using the task primitive creation form presented above with reference to FIG. 4. The created task primitive includes a task with a due date. The assignor sends the task primitive to the assignee thereby delegating the task to the assignee to complete.

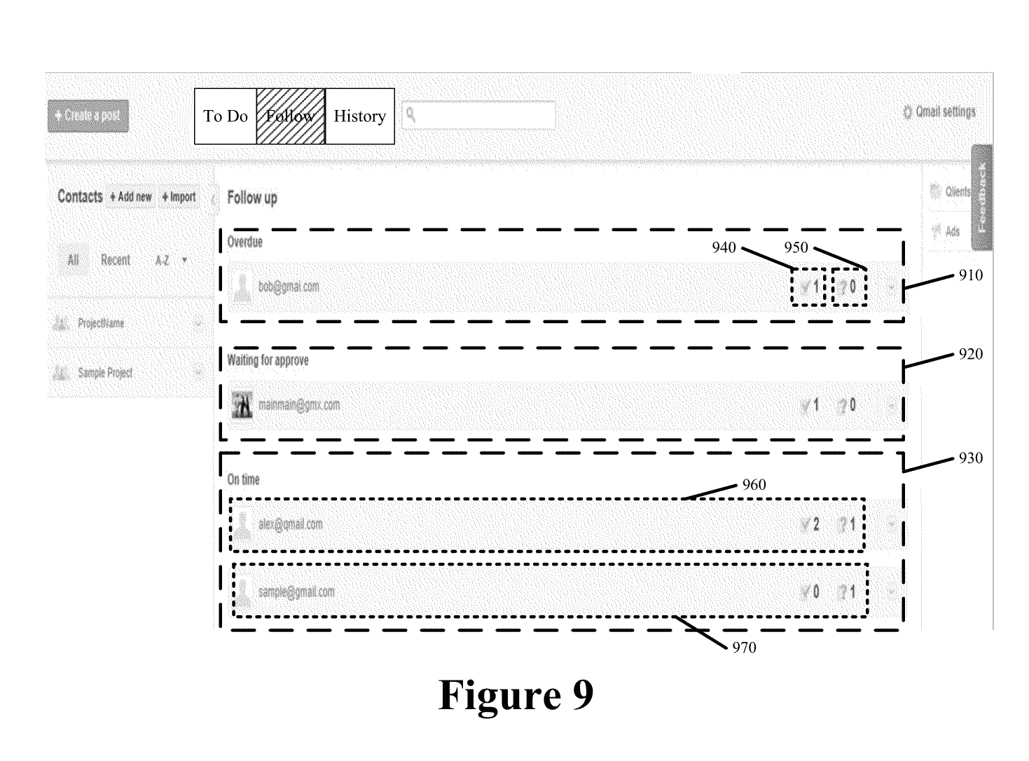

On the assignor side, the task primitive is entered (at 720) under the follow organizational heading of the assignor account so that the assignor can readily and automatically track tasks that the assignor assigned along with any outstanding questions that have yet to be answered from a single interface. Specifically and as will be discussed in further detail below with reference to FIG. 9, the follow organizational heading includes three sections including the overdue, waiting approval, and on-time sections. A task primitive is classified under the overdue section when there are no remaining days to complete the task and the task remains incomplete. A task primitive is classified under the waiting approval section when the assignee has changed the status of the task primitive to done and is waiting for the assignor to approve completion of the task. All other outstanding task primitives and question primitives are classified under the on-time section. With reference back to FIG. 7, the task primitive is classified under the all tasks and questions section at this stage in the workflow.

On the assignee side, the task primitive is entered (at 730) under the to-do organizational heading of the assignee. Also, the number of days that the assignee has left to complete the assigned task is displayed alongside the task. The task primitive can specify the same assignor and assignee. When the assignor and the assignee are the same, the task primitive serves as an appointment placeholder or reminder.

To ensure completion of the task, the workflow restricts the assignee to responding to an assigned task primitive by changing the status of the task to done. Additionally, the assignee forwards the task to another assignee. The assignee changes the status of the task to done when the assignee has executed the assigned task and is ready for the assignor to confirm completion of the task.

Upon the assignee changing the status of task primitive to done, the enhanced communication platform updates (at 740) the status of the task primitive in the to-do organizational heading of assignee account to waiting approval. Also, the enhanced communication platform enters (at 750) the task primitive under the waiting approval section of the follow organizational heading on the assignor account.

At this stage, the assignor can approve completion of the task primitive by setting the status of the task primitive to complete. In so doing, the task primitive is moved (at 760) under the history organizational heading of the assignor account and also moved under the history organizational heading of the assignee account (not shown). If the assignor does not approve completion of the task, the assignor can reply to the task primitive, provide notes as to why completion of the task was not approved, and also reset the due date for the task primitive. In this case, the task primitive is moved (at 770) back to the on-time section under the follow organizational heading of the assignor account and re-entered (at 780) in the to-do organizational heading of the assignee at which time the process repeats as described in the manner above.

The assignor of the task primitive also need not wait until the assignee changes the status of the task primitive to done before the assignor can complete the task primitive. At any time in the workflow of the task primitive, the assignor can approve a completed task by setting the status of the task primitive to complete. In some embodiments, once a task primitive is placed under the history organizational heading, the task primitive cannot be replied to or otherwise amended.

D. User Interfaces

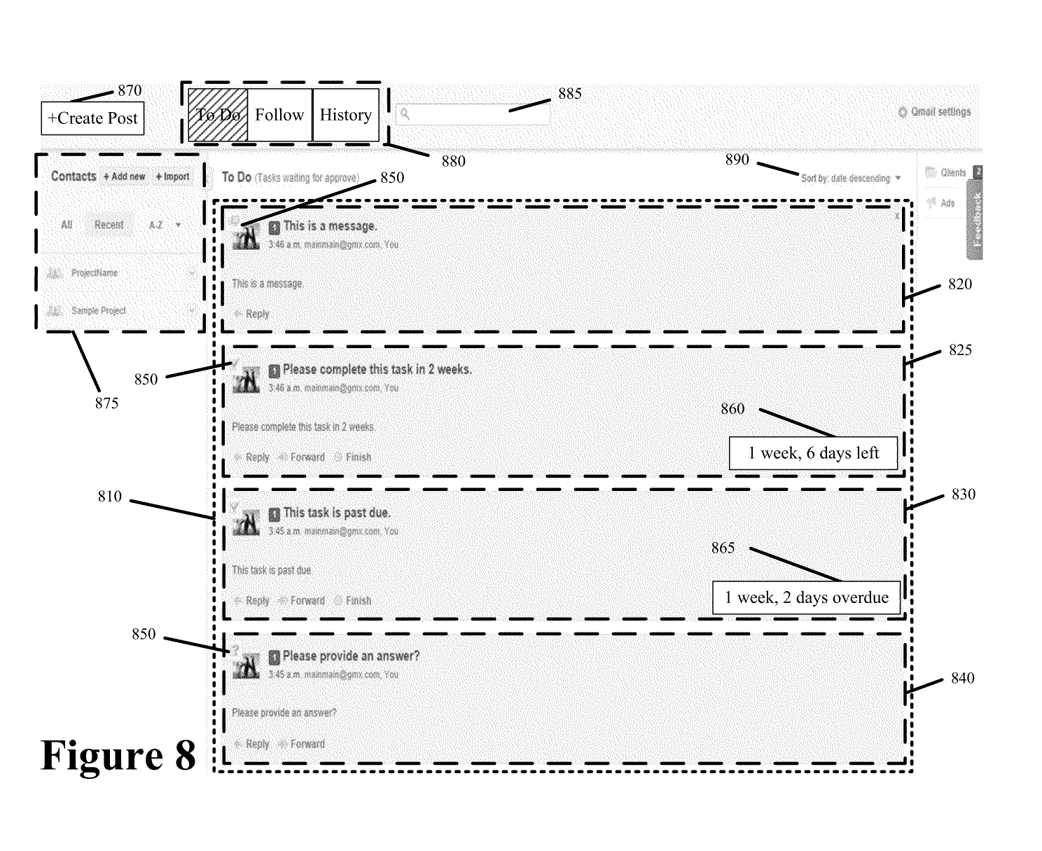

FIG. 8 presents a graphical interface that displays the primitives that are entered under the to-do organizational heading for a particular user in accordance with some embodiments. As shown, the interface includes a primary display area 810 that displays the primitives that are currently entered under the to-do organizational heading. In this figure, the user has four primitives 820, 825, 830, and 840 that are entered under the to-do organizational heading and, as a result, are displayed in the primary display area 810. An identifier (see 850) is presented adjacent to each primitive to identify the type of primitive. For instance, primitive 820 is identified as a message primitive by an identifier representing chat bubbles, primitive 825 is identified as a task primitive by an identifier representing a checkbox, primitive 830 is also identified as a task primitive, and primitive 840 is identified as a question primitive by an identifier representing a question mark. From the interface of FIG. 8, it is immediately evident that the user has one message primitive 820 that has not yet been closed, two task primitives 825 and 830 that have been assigned to the user and that the user has yet to complete, and one outstanding question primitive 840 that the user has yet to answer.

Each primitive 820-840 is also displayed with the contact information for the sender (typically an email address), image or icon of the sender, title, body, and timestamp. The task primitive 825 also includes a due date indicator 860 for the remaining number of days that the user is allotted to complete the assigned task, whereas the task primitive 830 includes a due date indicator 865 indicating the number of days the task is past due.

As will become apparent, the interface also includes UI elements that are available across all organizational headings. These shared elements include the new post UI element 870, list of contacts 875, organizational heading selection UI elements 880, search field 885, and sorting parameters 890 as some examples. The new post UI element 870 can be a button from which to initiate a new post primitive with the user having the option to select between the message, question, and task primitives. The list of contacts 875 provides the contact information for contacts of the user. The organizational heading selection UI elements 880 can be buttons that access the different organizational headings and the underlying primitives entered under each heading. The search field 885 is a query field by which a user can search the primitives under a specific organizational heading or under all headings. The sorting parameters 890 alter the way by which the primitives under the currently selected organizational heading are displayed.

FIG. 9 presents a graphical interface that displays the follow organizational heading for a user in accordance with some embodiments. As noted above, the follow organizational heading is divided into three sections 910, 920, and 930.

The first section 910 lists assignees that have received tasks (i.e., assigned task primitives) from the user and the tasks are now overdue as a result of the assignees not having completed the tasks by the user specified due date. For each assignee, the organizational heading specifies the number of overdue assigned tasks 940 and the number of outstanding questions is associated with that task 950.

The second section 920 lists assignees that have changed the status of tasks assigned by the user to done and, as a result, the tasks are now awaiting approval of the user to confirm completion of the tasks. In this figure, the user has one task primitive that awaits the user's approval. To approve the task, the user selects the task primitive representation under the second section 920 to pull up a detailed view of the task.

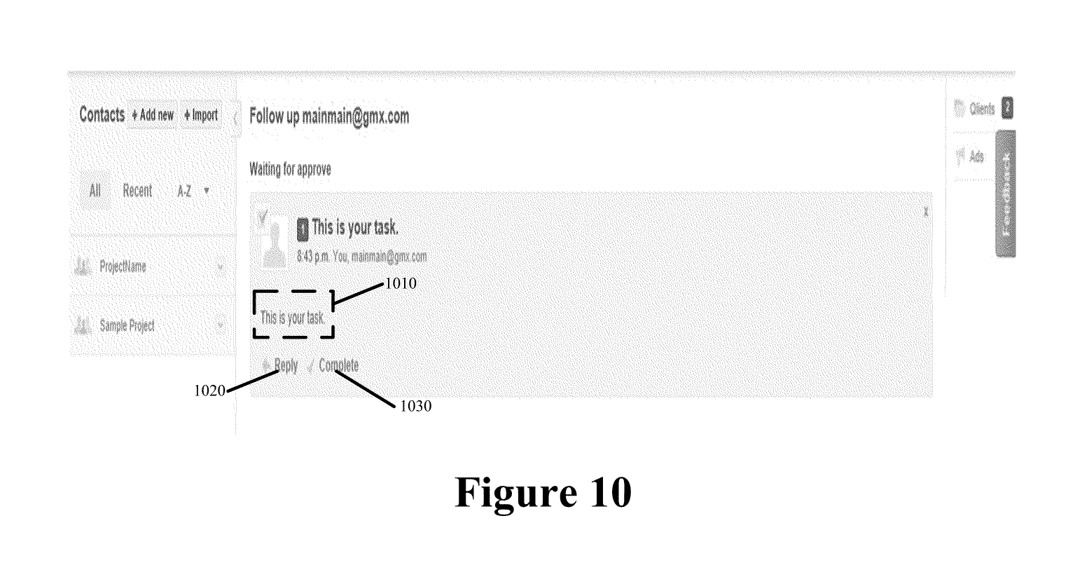

FIG. 10 illustrates an exemplary interface presenting the detailed view of a task that is awaiting user approval in accordance with some embodiments. As shown, the task primitive is expanded to present the task associated with the task primitive 1010 as well as a first button 1020 for the assignor to reply to the assignee and a second button 1030 for the assignor to complete the task. With reference back to FIG. 9, a completed and approved task is relocated from the second section 920 to the history organizational heading.

The third section 930 displays (1) the question primitives sent by the user that have not yet been answered and (2) the task primitives assigned by the user that have not been completed and that are not yet due. As shown in FIG. 9, the user has assigned two tasks and one question to user “alex@qmail.com” as indicated by UI element 960 and one question to user “sample@gmail.com” as indicated by UI element 970. Selecting UI element 960 provides a detailed view of the two outstanding tasks and one outstanding question associated with user “alex@qmail.com” under the third section 930. In other words, the interface expands to display the specific information regarding the two outstanding tasks and one outstanding question.

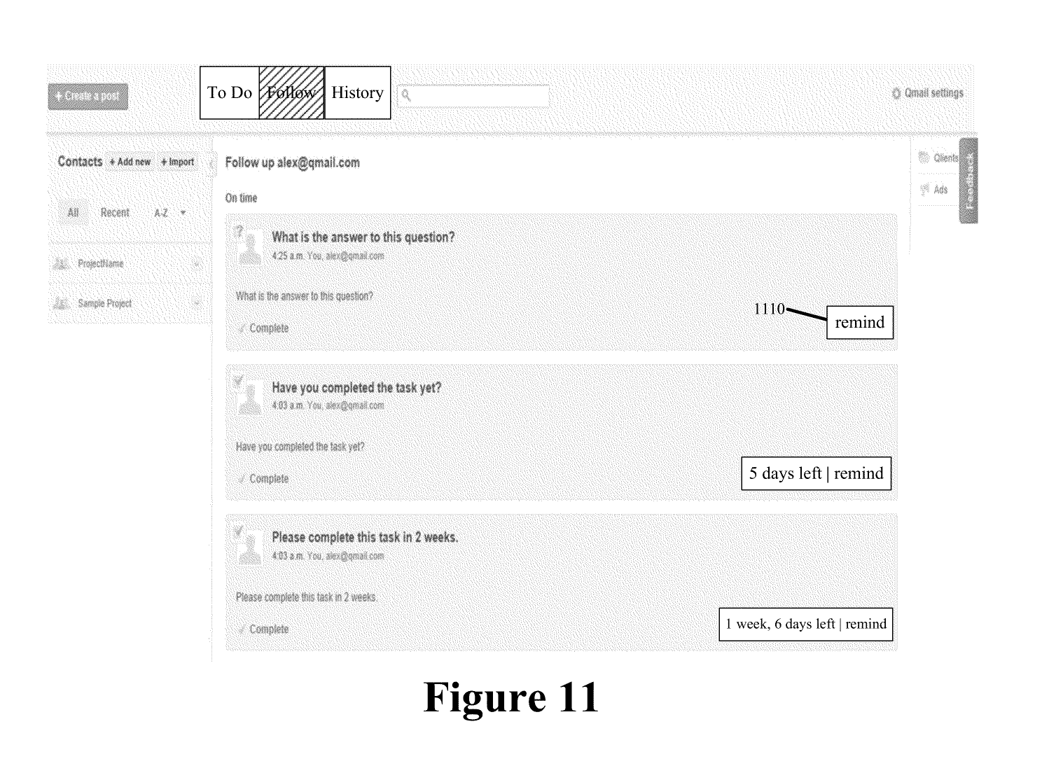

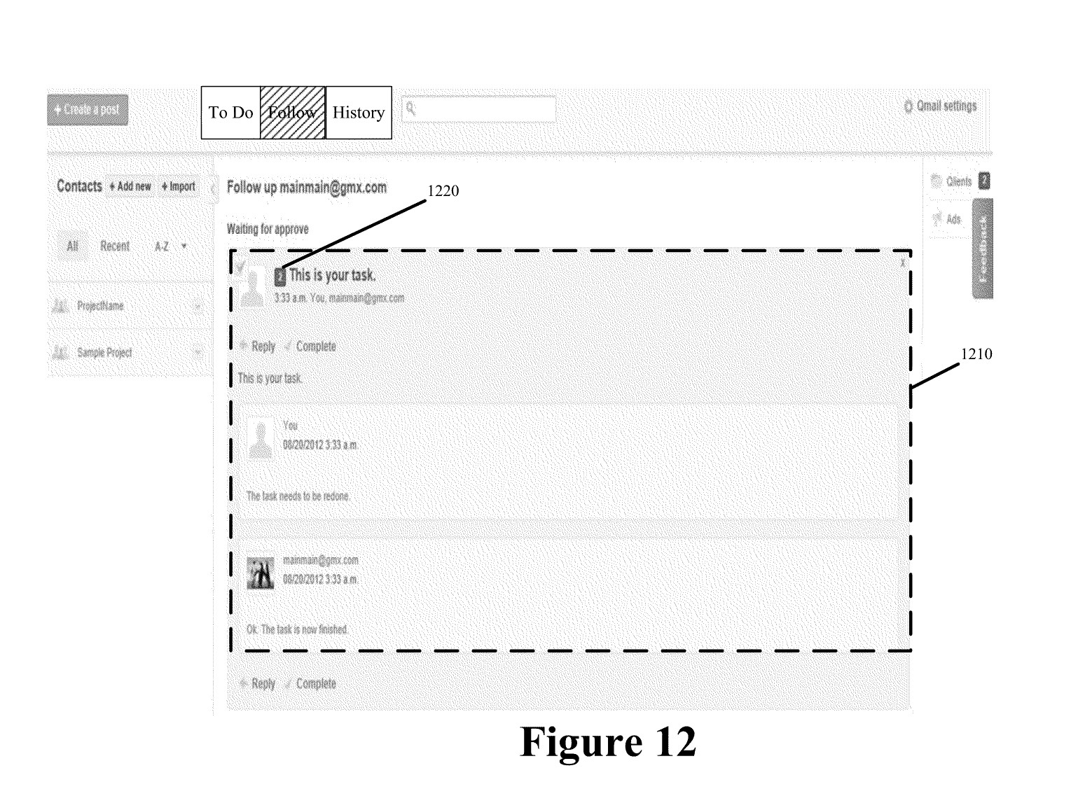

FIG. 11 illustrates a detailed view presenting two incomplete tasks and one unanswered question that a user has passed to another user in accordance with some embodiments. Selecting a specific primitive then causes the interface to display the entire conversation associated with that primitive should a conversation exist for that specific primitive. For example, FIG. 12 illustrates an expanded conversation 1210 for a task primitive. The number of messages in the conversation is indicated by the identifier 1220.

A question primitive that is answered is relocated from section 930 to the history organizational heading. The user can also approve completion of a task that is listed under the third section 930 without the assignee having changed the status of the task to done. As described above, the user selects the corresponding task primitive to pull up the detailed view of the task. The user can then approve completion of the task, delete the task, or provide a reply to the assignee.

Also with reference back to FIG. 11, senders can provide receivers reminders about unanswered questions and unfinished tasks. The reminders can take form as push notifications, wherein the push notifications may be sent as new message primitives or as pop-ups. A push notification can be sent by accessing the follow organizational heading (see FIG. 9), selecting a specific receiver to receive the push notification in order to bring up the outstanding question or task primitives sent to that user (see FIG. 11). When in the follow organizational heading, the user can then invoke the “remind” UI element that is displayed adjacent to each outstanding question primitive or task primitive. The push notification is sent from the same account from which the question primitive or task primitive is sent. The push notification is sent to the receiver's email account or to-do organizational heading.

Some embodiments allow senders or receivers to specify when they would like automatic reminders to be sent. For example, a receiver can specify an automatic reminder to be sent to himself three days before a due date. As another example, a sender can specify an automatic reminder to be sent to any receivers that have been assigned task and that have two days remaining to complete the task. Reminders can be sent as message primitives or as pop-ups that require the receiver to manually close the pop-ups.

Moreover, should a user not access his account at the enhanced communication platform for a specified time period, the platform can forward the reminders as regular email messages to an alternate email account of the user. The user identifies the alternate email account to the enhanced communication platform when registering for an account of the enhanced communication platform or when populating a profile associated with his/her enhanced communication platform account.

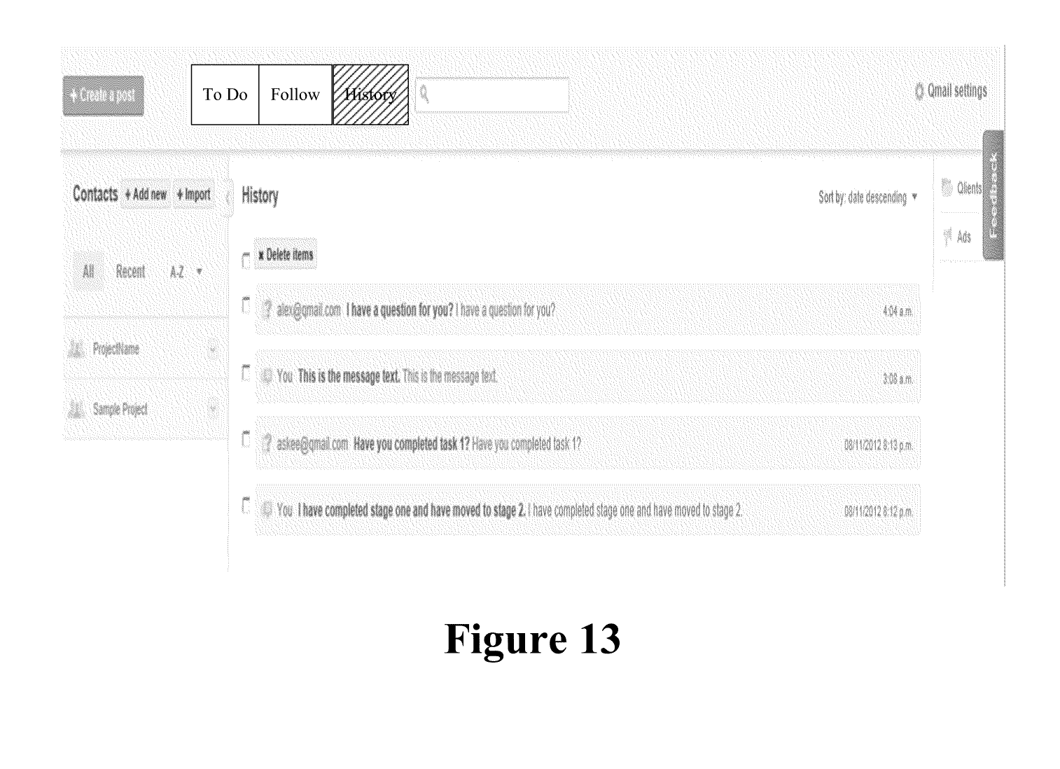

FIG. 13 presents a graphical interface that displays the primitives that are entered under the history organizational heading for a particular user in accordance with some embodiments. From this interface, the user can see all completed tasks, all answered questions, and all sent or read messages. The primitives under the history organizational heading are ordinarily listed from newest to oldest. However, using the sorting UI element (see 890 of FIG. 8), the user can change how the primitives under the history organizational heading and other organizational headings are sorted. For example, users can sort the primitives by post date (i.e., origination date) and can sort task primitives by due date. For any primitive in the history organizational heading that contains multiple posts for a conversation, the conversation can be expanded by selecting the UI element corresponding to the listed primitive in the history organizational heading.

Based on the above described workflows, the enhanced communication platform provides automated task management functionality to automatically differentiate between important posts that require a response or action from those that require no such response, action, or where the response or action is optional. Stated differently, the enhanced communication platform provides integrated tools that address different business collaboration objectives in a seamless interface that preserves the ease and familiarity of traditional email. These integrated tools provide specialized task management functions that render the enhanced communication platform a more effective and more efficient collaboration platform than traditional email while avoiding the fragmentation that occurs when using traditional email with other third party task management applications.

III. Other Functions

To register for an account with the enhanced communication platform, a user completes a signup form. The signup form is accessible and can be submitted from an online interface of the enhanced communication platform. In some embodiments, registration requires the user to at least specify his/her name and a password for the account. Additionally, registration may require the user specify at least one other email account that he/she has registered with another service provider. Once registered, the enhanced communication platform provides the user with a new account from which the user can send and receive any of the primitives according to the defined workflows. A user logs in to a created account by way of a username and password combination. The username may be custom specified or may be another email address.

Users can also merge existing accounts to the enhanced communication platform account such that the account at the enhanced communication platform is a unified account from which a user can access email from several accounts while still having access to the primitives and workflows set forth herein. To do so, a user specifies necessary information of the other accounts such that the enhanced communication platform can access those accounts, import any messages from those accounts to the user registered enhanced communication platform account, and send messages from any such accounts. Some such information may include the email address, login credentials to the email account, type of email account (e.g., POP3, IMAP, or HTTP), SMTP server address and port, and POP3/IMAP address as some examples.

Contacts can be imported from the external accounts to the enhanced communication platform account. Additionally, users can manually enter contacts to associate with their account. In some embodiments, entering a contact includes providing an identifying name for the contact and an email address for the contact, wherein the email address is an enhanced communication platform email address or an email address of a third party email service provider. Other identifying information including street address, telephone number, organization, photo, website, etc. can also be entered as part of a contact.

Other functionality of the enhanced communication platform includes filtering and sorting posts. Posts can be filtered to show all posts from a given contact by pressing on a UI element corresponding to that contact from the contact list. The platform also allows for searching by contact name, keywords, or date. Searches can be conducted under a specific organizational heading or for all organizational headings.

IV. Computer System

Many of the above-described processes and components are implemented as software processes that are specified as a set of instructions recorded on non-transitory computer-readable storage medium (also referred to as computer-readable medium). When these instructions are executed by one or more computational element(s) (such as processors or other computational elements like ASICs and FPGAs), they cause the computational element(s) to perform the actions indicated in the instructions. Server, computer, and computing machine are meant in their broadest sense and may include any electronic device with a processor that executes instructions stored on computer-readable media or that are obtained remotely over a network connection. Examples of computer-readable media include, but are not limited to, CD-ROMs, flash drives, RAM chips, hard drives, EPROMs, etc. Further, wherever a server is identified as a component of the embodied invention, it is understood that the server may be a single physical machine, or a cluster of multiple physical machines performing related functions, or virtualized servers co-resident on a single physical machine, or various combinations of the above.

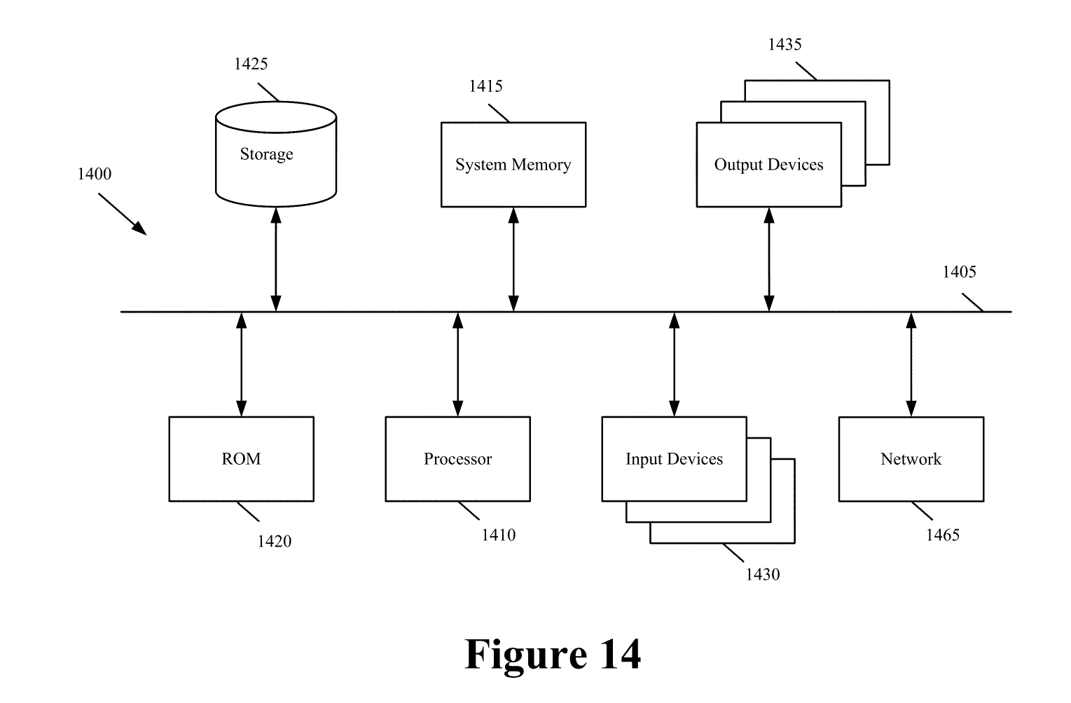

FIG. 14 illustrates a computer system or server with which some embodiments are implemented. Such a computer system includes various types of computer-readable mediums and interfaces for various other types of computer-readable mediums that implement the processes for the enhanced communication platform described above (e.g., MUA, MTP server, and MDA server). Computer system 1400 includes a bus 1405, a processor 1410, a system memory 1415, a read-only memory 1420, a permanent storage device 1425, input devices 1430, and output devices 1435.

The bus 1405 collectively represents all system, peripheral, and chipset buses that communicatively connect the numerous internal devices of the computer system 1400. For instance, the bus 1405 communicatively connects the processor 1410 with the read-only memory 1420, the system memory 1415, and the permanent storage device 1425. From these various memory units, the processor 1410 retrieves instructions to execute and data to process in order to execute the processes of the invention. The processor 1410 is a processing device such as a central processing unit, integrated circuit, graphical processing unit, etc.

The read-only-memory (ROM) 1420 stores static data and instructions that are needed by the processor 1410 and other modules of the computer system. The permanent storage device 1425, on the other hand, is a read-and-write memory device. This device is a non-volatile memory unit that stores instructions and data even when the computer system 1400 is off. Some embodiments of the invention use a mass-storage device (such as a magnetic or optical disk and its corresponding disk drive) as the permanent storage device 1425.

Other embodiments use a removable storage device (such as a flash drive) as the permanent storage device. Like the permanent storage device 1425, the system memory 1415 is a read-and-write memory device. However, unlike the storage device 1425, the system memory is a volatile read-and-write memory, such as random access memory (RAM). The system memory stores some of the instructions and data that the processor needs at runtime. In some embodiments, the processes are stored in the system memory 1415, the permanent storage device 1425, and/or the read-only memory 1420.

The bus 1405 also connects to the input and output devices 1430 and 1435. The input devices enable the user to communicate information and select commands to the computer system. The input devices 1430 include, but are not limited to, alphanumeric keypads (including physical keyboards and touchscreen keyboards) and pointing devices (also called “cursor control devices”). The input devices 1430 also include audio input devices (e.g., microphones, MIDI musical instruments, etc.). The output devices 1435 display images generated by the computer system. The output devices include, but are not limited to, printers and display devices, such as cathode ray tubes (CRT) or liquid crystal displays (LCD).

Finally, as shown in FIG. 14, bus 1405 also couples computer 1400 to a network 1465 through a network adapter (not shown). In this manner, the computer can be a part of a network of computers (such as a local area network (“LAN”), a wide area network (“WAN”), or an Intranet, or a network of networks, such as the Internet.

As mentioned above, the computer system 1400 may include one or more of a variety of different computer-readable media. Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ZIP® disks, read-only and recordable blu-ray discs, any other optical or magnetic media, and floppy disks.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

I claim:

1. A computer-implemented graphical user interface (GUI) comprising:
a user interface element for generating any of (i) a message primitive comprising a message, (ii) a question primitive comprising a question, and (iii) a task primitive comprising an assignable task;
a first selectable heading configured to display (i) a message primitive received by a user comprising a message that is unread, (ii) a question primitive received by the user comprising a question that is unanswered, and (iii) a task primitive received by the user comprising a task that is incomplete;
a second heading configured to display (i) a question primitive comprising an unanswered question that the user has asked a receiver and (ii) a task primitive comprising status of an incomplete task that the user has assigned to a receiver; and
a third heading configured to display each of a message primitive comprising a message that is read, a question primitive comprising a question that is answered, and a task primitive comprising a task that is complete.

2. The computer-implemented GUI of claim 1, wherein the second heading comprises at least a first section and a second section, the first section configured to display a task primitive comprising a task that is overdue, and the second section configured to display a task primitive comprising a task that is awaiting approval of the user.

3. The computer-implemented GUI of claim 2, wherein the second heading further comprises a third section configured to display any question primitives comprising an unanswered question and any task primitives comprising an incomplete task sent by the user to any receiver.

4. The computer-implemented GUI of claim 1 further comprising an indicator displayed adjacent to the task primitive in the first selectable heading, said indicator displaying an interval for completing the task.

5. The computer-implemented GUI of claim 1 further comprising a first indicator displayed adjacent to a message primitive to identify the message primitive as a message, a second indicator displayed adjacent to a question primitive to identify the question primitive as a question, and a task indicator displayed adjacent to a task primitive to identify the task primitive as a task.

6. The computer-implemented GUI of claim 1 further comprising a list of contacts that the user can submit any of the message primitive, question primitive, and task primitive to.

7. A collaboration platform integrating communication and task management, the collaboration platform executing a computer-implemented method comprising:
providing a message primitive comprising a construct for passing a message from an account of a sender to an account of a receiver without requiring further action by the receiver;
providing a question primitive comprising a construct for the sender to ask a question and receive a response to the question from the receiver;
performing a receiver-side workflow defined for the question primitive, the receiver-side workflow comprising:
receiving the question primitive at the receiver account;
presenting the question primitive under a first classification in the receiver account;
passing a response to the question primitive from the receiver account to the sender account;
removing the question primitive from the first classification in the receiver account in response to passing the response to the question primitive; and
entering the question primitive and the response under a second classification in the receiver account.

8. The computer-implemented method of claim 7 further comprising performing a sender-side workflow, wherein performing the sender-side workflow comprises
passing the question primitive from the sender account to the receiver account;
entering the question primitive under a third classification in the sender account;
receiving a response to the question primitive from the receiver account at the sender account;
presenting the response to the question primitive under the first classification in the sender account; and
relocating the question primitive and the response to the second classification in the sender account upon the sender viewing the response.

9. The computer-implemented method of claim 7 further comprising performing a receiver-side message primitive workflow, wherein performing the receiver-side message primitive workflow comprises
receiving the message primitive at the receiver account;
presenting the message primitive under the first classification in the receiver account; and
relocating the message primitive from the first classification in the receiver account to the second classification in the receiver account after the receiver closes the message primitive under the first classification.

10. The computer-implemented method of claim 7 further comprising performing a workflow defined for the message primitive that is different than the workflow defined for the question primitive.

11. The computer-implemented method of claim 10 further comprising providing a task primitive, the task primitive comprising a construct for the sender to assign a task to the receiver and to monitor status of the task.

12. The computer-implemented method of claim 11 further comprising performing a workflow defined for the task primitive that is different than the workflow defined for the message primitive and the workflow defined for the question primitive.

13. A collaboration platform integrating communication and task management, the collaboration platform executing a computer-implemented method comprising:
providing a message primitive comprising a construct for passing a message from an account of a sender to an account of a receiver without requiring further action by the receiver;
providing a task primitive comprising a construct for the sender to assign a task to a receiver and to monitor status of the task;
performing a receiver-side workflow defined for the task primitive, the receiver-side workflow comprising:
receiving the task primitive at the receiver account;
presenting the task primitive under a first organizational heading in the receiver account;
passing a status update from the receiver account to the sender account indicating completion of the task by the receiver;
receiving a confirmation from the sender account indicating that the sender has approved completion of the task; and
relocating the task primitive from the first organizational heading to a second organizational heading in the receiver account in response to receiving the confirmation.

14. The computer-implemented method of claim 13, wherein performing the receiver-side workflow further comprises identifying that the task is nearing a completion due date and providing a reminder to the receiver account to remind the receiver to complete the task.

15. The computer-implemented method of claim 13 further comprising performing a sender-side workflow, wherein performing the sender-side workflow comprises
passing the task primitive from the sender account to the receiver account;
entering the task primitive under a second organizational heading in the sender account;
receiving the status update from the receiver account indicating completion of the task by the receiver;
changing status of the task primitive under the second organizational heading to indicate that the task has been performed by the receiver;
receiving confirmation from the sender confirming completion of the task by the receiver;
moving the task primitive from the second organizational heading to the third organizational heading in the sender account.

16. The computer-implemented method of claim 15, wherein performing the server-side workflow further comprises specifying a due date by which the task is to be completed by the receiver.

17. The computer-implemented method of claim 16, wherein performing the server-side workflow further comprises providing a reminder to the receiver account to remind the receiver to complete the task when the due date is within a defined threshold.

18. The computer-implemented method of claim 15, wherein entering the task primitive under the second organizational heading comprises entering the task primitive to a first subheading under the second organizational heading when the task is past due and entering the task primitive to a second subheading under the second organizational heading when the task is past due.

19. The computer-implemented method of claim 13 further comprising performing a receiver-side message primitive workflow, wherein performing the receiver-side message primitive workflow comprises
receiving the message primitive at the receiver account;
presenting the message primitive under the first organizational heading in the receiver account; and
relocating the message primitive from the first organizational heading in the receiver account to the second organizational heading in the receiver account after the receiver closes the message primitive under the first organizational heading.
